(19) United States
(12) Patent Application Publication
(10) Pub. No.: US 2020/0039195 A1
(43) Pub. Date: Feb. 6, 2020

(54) METHOD FOR IMPROVING THE ADHESION OF SILICONE ON A THERMOPLASTIC SURFACE

(71) Applicant: Universität Kassel, Kassel (DE)

(72) Inventors: Ralf Urs Giesen, Malsfeld (DE); Annette Rüppel, Melsungen (DE); Michael Hartung, Knüllwald (DE); Hans-Peter Heim, Gütersloh (DE)

(21) Appl. No.: 15/999,763

(22) PCT Filed: Dec. 13, 2016
(86) PCT No.: PCT/DE2016/100581

§ 371 Date: Aug. 20, 2019

(30) Foreign Application Priority Data
Feb. 20, 2016 (DE) 10 2016 002 011.3

(51) Int. Cl. B32B 27/16; B32B 27/34; B32B 27/36; B32B 27/32; B32B 27/30; B32B 25/20; B32B 37/24; B32B 7/04; B32B 25/18; C09J 5/02; B29C 45/16

(52) U.S. Cl. CPC B32B 27/16; B32B 27/34; B32B 27/365; B32B 27/32; B32B 27/302; B32B 27/308; B29K 2083/00; B32B 37/24; B32B 7/04; B32B 25/18; C09J 5/02; B29C 45/16; B32B 25/20

(57) ABSTRACT

A method for improving adhesion of a self-adhesive silicone on a surface of a thermoplastic material. The surface of the thermoplastic material is irradiated with UV-C radiation. A composite of a thermoplastic and a silicone applied to a surface of the thermoplastic, wherein the thermoplastic is irradiated by the method using UV-C radiation.

### CROSS-REFERENCE TO RELATED APPLICATION

This application is the U.S. national stage of co-pending international application no. PCT/DE2016/100581 filed Dec. 13, 2016, which designated the United States of America; this application also claims priority of German patent application DE 10 2016 002 011.3 filed Feb. 20, 2016; the prior applications are herewith incorporated by reference in their entirety.

### FIELD OF INVENTION

The invention relates to a method for improving the adhesion of silicone on the surface of a thermoplastic. The invention is further directed to a composite of a thermoplastic and of a silicone applied to a surface of the thermoplastic.

### BACKGROUND OF THE INVENTION

A method of bonding two thermoplastic surfaces is known from U.S. Pat. No. 8,293,061 B2 and it is specified that the thermoplastic surfaces can be irradiated with UV-C radiation to activate the surfaces. The bond strength of the thermoplastic-thermoplastic connection is thereby increased. Such a surface activation is based on the generation of oxygen radicals from the air that react with radicals on the material surface. A chemically modified surface of the thermoplastic is thereby produced. The two thermoplastic surfaces can consequently be brought to one another and can be connected to one another in a bonding process.

If materials are to be connected to one another that are not the same, that is, for example, a silicone and a thermoplastic, different activation processes are known to activate the surface of the thermoplastic so that an improvement of the adhesion of the silicone is achieved. The silicone here should, for example, be applied to the surface of the thermoplastic in an injection molding process. Bonding agents are known that can be used as additivations of the thermoplastic; it is likewise known to correspondingly additivate the material of the silicone to produce a bonding agent. Such additivations disadvantageously result in a substantial increase in costs in the procuring of correspondingly additivated thermoplastics or silicones.

An activation of the thermoplastic surface by means of a so-called corona treatment is furthermore known and the corona process is based on an alternating electrical discharge in air atmosphere. High-energy electrons that are produced form radicals on the material surface that react by means of oxygen radicals from the air that are likewise formed.

A further physical process for a surface treatment is flaming. Molecular compounds at the substrate surface are broken by the action of the gas flame and allow the introduction of radicals from the flame into the molecular chain. The polar groups produced at the substrate surface are able to bond with other materials.

In addition to flaming, an activation of the thermoplastic surface by means of a plasma is furthermore known. On a plasma activation, a directed modification of a surface tension of the thermoplastic is achieved by plasma energy, whereby a substantial improvement in adhesion is likewise achieved.

The different methods known from the prior art for the surface activation of a thermoplastic for the bonding with a silicone are accompanied by a number of different disadvantages. A warping of the workpiece can, for example, occur in a thermal process such as flaming; color changes of the surface can likewise result. In a plasma technique or in a corona treatment, complex and/or expensive system technologies are required and hazards in particular arise for the operator at high electrical voltages of system components. High operating costs, high energy requirements, and high investment costs are further factors that make an alternative process seem necessary for the activation of the surface of a thermoplastic for the bonding of a silicone.

### SUMMARY OF THE INVENTION

It is the object of the invention to develop a method for improving the adhesion of silicone on the surface of a thermoplastic with which the disadvantages of the above-described prior art are avoided. An improvement of the adhesion of silicone on the surface of a thermoplastic should in particular be achieved.

The invention includes the technical teaching that the surface of the thermoplastic is irradiated by a UV-C radiation to improve the adhesion of silicone on the surface.

The invention makes use of UV-C radiation to activate the surface of the thermoplastic to specifically achieve an improvement in the adhesion of silicone on the surface. If the silicon is applied to the surface after the irradiation, a substantial improvement in adhesion of the silicone on the thermoplastic can be seen. The method here specifically provides a selective irradiation of the surface in the regions in which the silicone should be applied to the surface. Adjacent surface regions of the thermoplastic to which the silicone should not adhere can, for example, be covered prior to the UV-C radiation.

The UV-C radiation is particularly advantageously provided at a wavelength of 100 nm to 280 nm, preferably of 150 nm to 200 nm, and particularly preferably of 180 nm to 190 nm. Particularly good results were surprisingly able to be achieved at a wavelength of the UV-C radiation of 185 nm.

The UV-C radiation is further advantageously produced by means of a radiation source, with the radiation source being moved over the surface of the thermoplastic during the irradiation. For example, the UV-C radiation can travel over the surface regions of the thermoplastic workpiece such that the regions of the surface are activated that should be bonded with the silicone. It is also conceivable that the radiation source is arranged and operated in a stationary manner above the surface of the thermoplastic and a corresponding mask can, for example, be used to activate targeted regions and to exclude further regions from the activation.

In accordance with an advantageous further development of the method in accordance with the invention, the irradiation of the surface of the thermoplastic is carried out within an irradiation chamber darkened to the outside. The irradiation chamber is thus in particular configured such that no UV-C radiation can exit the irradiation chamber. A hazard to the operator emanating from the UV-C radiation is thus, for example, precluded in a simple manner. The irradiation chamber can be designed so that the thermoplastic workpiece can be placed into the irradiation chamber. The radiation source can furthermore be arranged within the irradiation chamber.

The irradiation of the surface of the thermoplastic by means of UV-C radiation is further advantageously carried out while forming ozone, with the ozone interacting with the surface during the irradiation. It has been found on the irradiation of thermoplastic materials with UV-C radiation that ozone is formed by the interaction with the air atmosphere, with the ozone in turn producing a substantial improvement in the activation of the surface in interaction with the surface of the thermoplastic. The ozone formed is consequently additionally used to produce the improvement of the adhesion of silicone on the surface of the thermoplastic.

If the irradiation is carried out within a closed space, in particular within an irradiation chamber darkened to the outside, the advantage is in particular achieved in conjunction with the ozone that the ozone remains in the region of the thermoplastic close to the surface and can enter into corresponding interaction with the surface. Provision can additionally be made for the amplification of this effect to correspondingly optimize the irradiation chamber to ensure an interaction of the ozone with the surface that is as intense as possible. The irradiation chamber is, for example, selected as so small in size that a concentration of the ozone above the surface of the thermoplastic is present that is as high as possible.

The duration of the irradiation amounts, for example, to three seconds up to fifteen minutes. The irradiation time in particular amounts to five seconds to thirty seconds so that very good adhesion results of the silicone on the thermoplastic surface can already be achieved.

The method, on the one hand, provides for the provision of a thermoplastic material; on the other hand, a silicone is provided that is to be connected to the thermoplastic. A polyamide, for example a PA6 GF25, a polycarbonate, a polypropylene, a methyl methacrylate acrylonitrile butadiene styrene, a methyl methacrylate, or an acrylonitrile butadiene styrene is provided as the thermoplastic. A liquid silicone rubber or a high consistency silicone rubber can be provided as the silicone. The silicone in the form of the liquid silicone rubber, abbreviated to LSR, is in particular provided as a self-adhesive LSR.

The method is in particular suitable for preparing the surface of a thermoplastic to inject the silicone onto the thermoplastic in an injection molding process. The vulcanization temperature here amounts, for example, to 170° F. for PA6 GF25, to 140° F. for polycarbonate, and to 80° F. for polypropylene, MABS, PMMA, and ABS. The vulcanization time can here be from twenty seconds to three hours. Peeling trials have shown that, in dependence on the material pairing, the peel resistance can be greater than the material strength, for example on the use of polycarbonate as the thermoplastic material, with the peel resistance likewise being greater than the material strength in compounds with MABS, PMMA, and ABS to which self-adhesive LSR was applied by UV-C radiation in the pre-treatment. The application of PP, MABS, PMMA, and ABS can take place manually here. Polycarbonate as a thermoplastic is in particular prepared by injection molding.

The invention is further directed to a composite of a thermoplastic and of a silicone applied to a surface of the thermoplastic, with the surface of the thermoplastic having been activated by the above-described method. The surface is in particular irradiated with UV-C radiation. The composite is in particular characterized in that a thermoplastic workpiece is first provided; the irradiation of the surface with UV-C radiation subsequently takes place and finally the silicone is applied to the activated surface by means of an injection molding process. A scarf joint, a T joint, an overlapping connection, or a complete or partial areal connection can be provided as a bond between a thermoplastic and a silicone.

### BRIEF DESCRIPTION OF THE DRAWINGS

Further measures improving the invention will be shown in more detail below together with the description of a preferred embodiment of the invention with reference to the Figures. There is shown:

FIG. 1 is a perspective view of a thermoplastic with a surface that is irradiated with UV-C radiation to improve the adhesion of silicone to the surface;

FIG. 2 is a cross-sectional view through a setup for irradiating a thermoplastic with UV-C radiation by means of a radiation source; and

FIG. 3 shows a composite of a thermoplastic with an applied silicone.

FIG. 4 a table with measured peel resistances for different material pairings of thermoplastics and silicones.

### DETAILED DESCRIPTION OF THE PREFERRED EMBODIMENTS

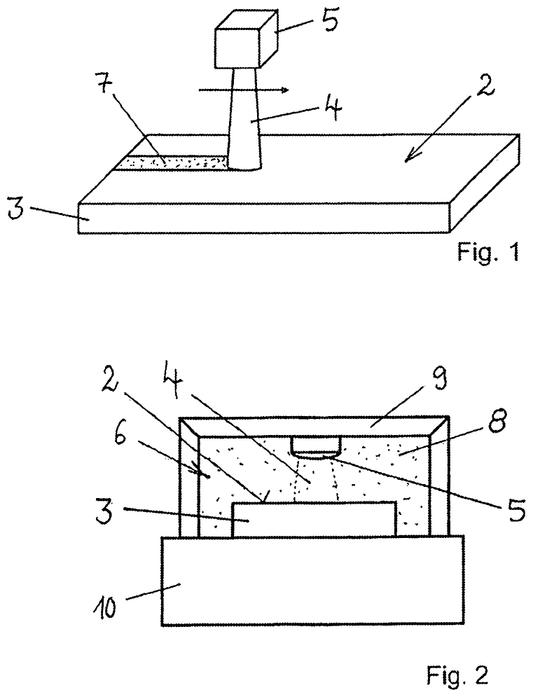

FIG. 1 schematically shows the irradiation of a surface 2 of a thermoplastic 3 with UV-C radiation 4. A radiation source 5 for producing the UV-C radiation 4 is schematically shown and the radiation source 5 is formed, for example by a gas discharge lamp, for example by a low-pressure lamp in the form of a mercury vapor lamp. The irradiation of the surface 2 produces an activation that is intended to serve the improvement of the adhesion of silicone on the surface 2. If the silicone is, for example, only applied to the surface 2 in discrete regions, for example by an injection molding process, only a part of the surface 2 is also activated so that an activated surface 7 is schematically shown over which the UV-C radiation 4 was conducted, which is indicated by an arrow. Alternatively, to the scanning of the surface to produce the activated surface 7 with the UV-C radiation 4, a mask or other shading means can also be used to keep parts of the surface 2 away from the irradiation and to active parts of the surface 2, as shown by the activated surface 7.

FIG. 2 shows a setup for irradiating the surface 2 of a thermoplastic 3 and the setup comprises a workpiece mount 10 for receiving the thermoplastic 3, with the surface 2 to be activated being directed in a direction toward a radiation source 5. The thermoplastic 3 is located in an irradiation chamber 6 that is bounded by a housing 9. If the surface 2 of the thermoplastic 3 is irradiated by UV-C radiation 4, ozone 8 is produced and the ozone 8 is held in contact with the surface 2 by the irradiation chamber 6 so that the ozone 8 can interact with the surface 2. The activation process is amplified by the presence of ozone 8 that is formed by the actual irradiation process, whereby the adhesion of silicone on the surface 2 of the thermoplastic 3 is further improved.

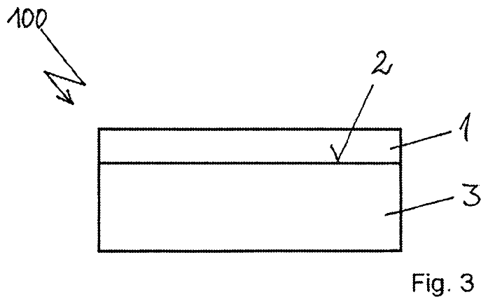

FIG. 3 shows a composite 100 of a thermoplastic 3 and a silicone 1 and the silicone 1 adheres to the surface 2 that was previously activated using the previously described method. The composite 100 can here comprise any form of thermoplastics and silicones, with the thermoplastic 3, for example being able to comprise a glass fiber reinforced polyamide, a polycarbonate, a polypropylene, a methyl methacrylate acrylonitrile butadiene styrene, a methyl methacrylate, or an acrylonitrile butadiene styrene and with the thermoplastic 3 forming a body, for example a component. The silicone 1 can comprise a liquid silicone rubber or a high consistency silicone rubber and the silicone 1, for example, serves as a sealing lip on the component composed of a thermoplastic material, for example a sealing lip for a housing cover, a soft handle for a brush, buttons for the operation of an electric device, membranes in thermoplastic components, windshield wipers and the like.

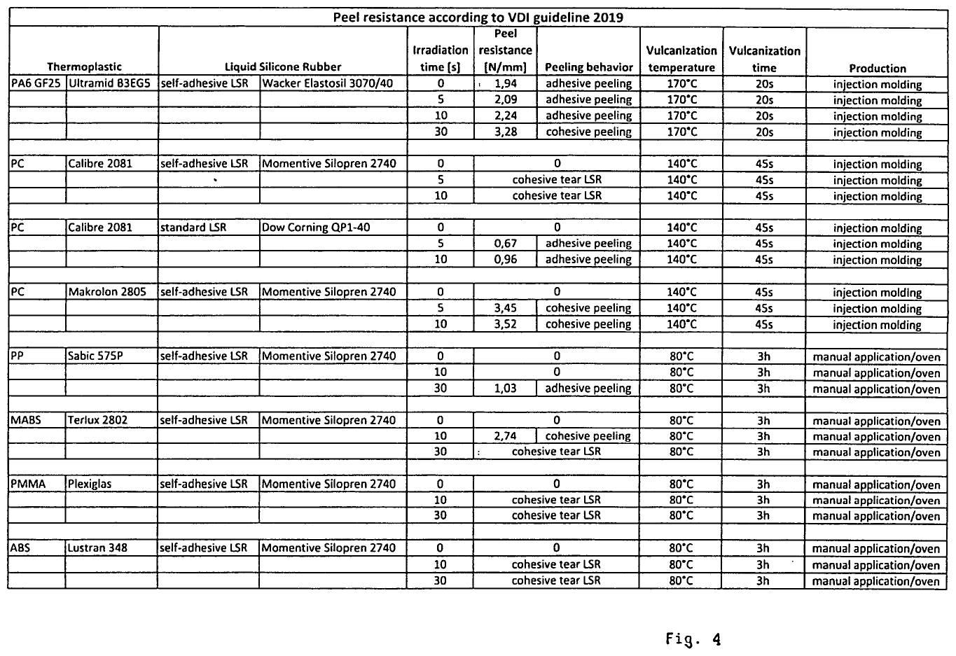

FIG. 4 shows measured peel resistances for different material pairings of thermoplastics and silicones. The plastics PA 6 GF25 (a glass fiber reinforced polyamide, PA) various polycarbonates (PC), polypropylene (PP), methyl methacrylate acrylonitrile butadiene styrene (MABS), methyl methacrylate and acrylonitrile butadiene styrene (ABS) are listed as thermoplastics. A self-adhesive LSR is listed as a silicone with the exception of a targeted material pairing with a polycarbonate, with a standard LSR being paired with the polycarbonate (Calibre 2081). The LSR silicone here corresponds to a liquid silicone rubber.

The peeling trials were carried out on the basis of VDI Guideline 2019. The irradiation times here reflect the times over which the surface of the thermoplastics was irradiated with the UV-C radiation. If no averaged peel resistances are indicated, a cohesion break is present, i.e. the silicone material has cracked in itself and not at the interface to the thermoplastic. The peel resistance is consequently then greater than the material strength of the LSR.

The vulcanization temperature relates to the temperature at which the liquid silicone rubber was vulcanized, with the vulcanization time simultaneously being indicated. The specimen production descries the form in which the liquid silicone rubber was applied to the surface of the thermoplastic.

As the peeling trials show, the peel resistance generally increases with the duration of the UV-C irradiation, with the irradiation having been carried out for up to thirty seconds. Particularly good results were obtained here with irradiation times from five seconds onward for the material of polycarbonate paired with self-adhesive LSR and with standard LSR. With an irradiation time of ten seconds, good peeling results were achieved with MABS, PMMA, and ABS.

The invention is not restricted in its design to the preferred embodiment specified above. A number of variants is rather conceivable that also makes use of the solution shown with generally differently designed embodiments. All the features and/or advantages, including any construction details or spatial arrangements, originating from the claims, the description, or the drawings can be essential to the invention both per se and in the most varied combinations.

### REFERENCE NUMERAL LIST

1 silicone
2 surface
3 thermoplastic
4 UV-C radiation
5 radiation source
6 irradiation chamber
7 activated surface
8 ozone
9 housing
10 workpiece mount
100 composite

1-10. (canceled)

11. A method for improving adhesion of a silicone on a surface of a thermoplastic, comprising:
irradiating a surface of a thermoplastic with Ultraviolet-C (UV-C) radiation.

12. A method in accordance with claim 11, wherein the UV-C radiation is provided at a wavelength of 100 nm to 280 nm, 150 nm to 200 nm or 180 nm to 190 nm.

13. A method in accordance with claim 11, wherein the UV-C radiation is produced by a radiation source and the radiation source is moved over the surface of the thermoplastic during the irradiating step.

14. A method in accordance with claim 11, wherein the step of irradiating the surface of the thermoplastic comprises carrying out the irradiation within an irradiation chamber having a closed space, the irradiation chamber being darkened to the outside.

15. A method in accordance with claim 11, wherein the irradiating step comprises irradiating the surface of the thermoplastic while forming ozone, with the ozone interacting with the surface during the irradiation.

16. A method in accordance with claim 11, wherein the irradiating step is carried out at a radiation power of 2 W to 1000 W and/or the irradiating step is carried out using a low-pressure lamp as a radiation source.

17. A method in accordance with claim 11, wherein the irradiating step comprises irradiating the surface at an irradiation duration of three seconds to fifteen minutes.

18. A method in accordance with claim 11, wherein the irradiating step further comprises selecting the thermoplastic from the group consisting of a glass fiber reinforced polyamide, a polycarbonate, a polypropylene, a methyl methacrylate acrylonitrile butadiene styrene, a methyl methacrylate and an acrylonitrile butadiene styrene.

19. A method in accordance with claim 11, wherein the irradiating step further comprises selecting the silicone from the group consisting of a liquid silicone rubber and a high consistency silicone rubber.

20. A method for improving adhesion of a silicone on a surface of a thermoplastic, comprising:
providing a thermoplastic having a surface;
irradiating the surface of the thermoplastic with Ultraviolet-C (UV-C) radiation; and
adhesing a silicone on the surface of the thermoplastic after irradiating.

21. A method in accordance with claim 20, wherein the UV-C radiation has a wavelength of 100 nm to 280 nm, 150 nm to 200 nm or 180 nm to 190 nm.

22. A method in accordance with claim 20, wherein the step of irradiating the surface of the thermoplastic comprises:
providing a radiation source for producing the UV-C radiation; and
moving the radiation source over the surface of the thermoplastic for irradiating the surface.

23. A method in accordance with claim 20, wherein the step of irradiating the surface of the thermoplastic comprises:
providing an irradiation chamber having a closed space, the irradiation chamber being darkened to the outside; and
carrying out the step of irradiating within the closed space.

24. A method in accordance with claim 20, wherein the step of irradiating the surface of the thermoplastic further comprises a step of forming ozone while irradiating the surface, with the ozone interacting with the surface during the irradiation.

25. A method in accordance with claim 20, wherein the step of irradiating the surface of the thermoplastic comprises:
carrying out the irradiation at a radiation power of 2 W to 1000 W; and/or
providing a low-pressure lamp as a radiation source and irradiating the surface using the low-pressure lamp.

26. A method in accordance with claim 20, wherein the irradiation is carried out at an irradiation duration of three seconds to fifteen minutes.

27. A method in accordance with claim 20, wherein the step of providing the thermoplastic further comprises selecting the thermoplastic from the group consisting of a glass fiber reinforced polyamide, a polycarbonate, a polypropylene, a methyl methacrylate acrylonitrile butadiene styrene, a methyl methacrylate and an acrylonitrile butadiene styrene.

28. A method in accordance with claim 20, wherein the step of adhesing the silicone further comprises selecting the silicone from the group consisting of a liquid silicone rubber and a high consistency silicone rubber.

29. A method in accordance with claim 20, wherein the step of adhesing the silicone comprises applying the silicone to the activated area using an injection molding process.
